(19) United States
(12) Patent Application Publication
(10) Pub. No.: US 2023/0026565 A1
(43) Pub. Date: Jan. 26, 2023

(54) METHOD OF INPUTTING AND OUTPUTTING DATA, ELECTRONIC DEVICE AND COMPUTER PROGRAM PRODUCT

(71) Applicant: EMC IP Holding Company LLC, Hopkinton, MA (US)

(72) Inventors: Long Wang, Beijing (CN); Shuguang Gong, Beijing (CN)

(21) Appl. No.: 17/508,261

(22) Filed: Oct. 22, 2021

(30) Foreign Application Priority Data
Jul. 20, 2021 (CN) 202110821259.2

(51) Int. Cl. G06F 3/06

(52) U.S. Cl. CPC G06F 3/064; G06F 3/0659; G06F 3/0656; G06F 3/0613; G06F 3/0673

(57) ABSTRACT

A method, an electronic device, and a computer program product for inputting and outputting data is disclosed. The method includes receiving a target I/O request for a storage device from an application, determining that a first offset or a second offset is greater than zero, and generating a plurality of I/O requests based on the target address. The I/O requests include a first I/O request for a first data segment in target data and at least one other I/O request for other data segments in the target data. For the first I/O request, the method includes executing a direct I/O operation on the first data segment by bypassing a cache associated with the storage device.

### CROSS REFERENCE TO RELATED APPLICATION

This application claims priority under 35 U.S.C. § 119 to Chinese Patent Application No. 202110821259.2, filed on Jul. 20, 2021. The contents of Chinese Patent Application No. 202110821259.2 are incorporated by reference in its entirety.

### TECHNICAL FIELD

Embodiments of the present disclosure relate to the field of storage systems, and more particularly, to a method, an electronic device, and a computer program product for inputting and outputting data.

### BACKGROUND

In conventional bare metal platforms, a specially designed NVRAM (Non-Volatile Random Access Memory) card is commonly used, and the NVRAM card has a performance-optimized design to ensure performance, data integrity, and reliability. NVMe (Non-Volatile Memory Express) is a communication interface and drive program that can make full use of a higher bandwidth provided by Peripheral Component Interconnect Express (PCIe). The NVMe technology brings outstanding storage space, speed, and compatibility. Since NVMe utilizes a PCIe slot, the amount of transmitted data is 25 times that of the same serial advanced technology attachment (SATA) product. Thanks to its own compatibility, NVMe also communicates with a system CPU directly with an amazing speed. An NVMe solid state drive is compatible with all major operating systems. NVME is specially designed for SSD, and uses high-speed PCIe slots to communicate between storage interfaces and system CPUs, and there is no external dimension limitation. An NVMe protocol utilizes a parallel and low-latency basic medium data channel similar to a high-performance processor architecture. This greatly enhances performance and reduces latency compared with SAS and SATA protocols. For example, the highest possible number of IO operations per second of a SATA solid state drive is only 200,000, while the highest possible number of IO operations per second of the NVME solid state drive exceeds 1 million.

### SUMMARY OF THE INVENTION

Embodiments of the present disclosure provide a solution for inputting and outputting data using an I/O method that mixes direct I/O with cache I/O.

In one aspect of the present disclosure, a method for inputting and outputting data is provided. The method includes receiving a target I/O request for a storage device from an application, wherein data in the storage device is organized into blocks having predetermined sizes, and the target I/O request indicates a target address of target data. The method further includes, in response to determining that the target address involves a plurality of blocks, determining a first offset between a start address of the target address and a start address of the plurality of blocks and a second offset between an end address of the target address and an end address of the plurality of blocks. The method further includes, in response to that the first offset or the second offset is greater than zero, generating a plurality of I/O requests based on the target address, the plurality of I/O requests including a first I/O request for a first data segment in target data and at least one other I/O request for other data segments in the target data, wherein a size of the first data segment is an integer multiple of a block size, and an offset between a start address of the first data segment and the start address of the plurality of blocks is also an integer multiple of the block size. The method further includes, for the first I/O request, executing a direct I/O operation on the first data segment by bypassing a cache associated with the storage device. The method further includes, for the at least one other I/O request, executing a cache I/O operation on the other data segments by the cache.

In another aspect of the present disclosure, an electronic device is provided. The electronic device includes a processor; and a memory coupled to the processor, the memory having instructions stored therein, wherein the instructions, when executed by the processor, cause the device to execute actions. The actions include receiving a target I/O request for a storage device from an application, wherein data in the storage device is organized into blocks having predetermined sizes, and the target I/O request indicates a target address of target data. The actions further include, in response to determining that the target address involves a plurality of blocks, determining a first offset between a start address of the target address and a start address of the plurality of blocks and a second offset between an end address of the target address and an end address of the plurality of blocks. The actions further include, in response to that the first offset or the second offset is greater than zero, generating a plurality of I/O requests based on the target address, the plurality of I/O requests including a first I/O request for a first data segment in target data and at least one other I/O request for other data segments in the target data, wherein a size of the first data segment is an integer multiple of a block size, and an offset between a start address of the first data segment and the start address of the plurality of blocks is also an integer multiple of the block size. The actions further include, for the first I/O request, executing a direct I/O operation on the first data segment by bypassing a cache associated with the storage device. The actions further include, for the at least one other I/O request, executing a cache I/O operation on the other data segments by the cache.

In another aspect of the present disclosure, a computer program product is provided that is tangibly stored on a non-transitory computer-readable medium and includes machine-executable instructions, wherein the machine-executable instructions, when executed, cause a machine to perform the method according to the first aspect.

The Summary of the Invention part is provided to introduce the selection of concepts in a simplified form, which will be further described in the Detailed Description below. The Summary of the Invention part is neither intended to identify key features or main features of the present disclosure, nor intended to limit the scope of the present disclosure.

### BRIEF DESCRIPTION OF DRAWINGS

The above and other objectives, features, and advantages of the present disclosure will become more apparent by describing example embodiments of the present disclosure in more detail with reference to the accompanying drawings. In the example embodiments of the present disclosure, the same reference numerals generally represent the same members. In the accompanying drawings,

FIG. 1 shows a schematic block diagram of an example storage system that performs direct I/O operations and cache I/O operations in accordance with embodiments disclosed herein;

FIG. 2 shows a schematic block diagram of a storage system according to one or more embodiments of the present disclosure;

FIG. 3 shows a flow chart of an example method for inputting and outputting data according to one or more embodiments of the present disclosure;

FIG. 4 shows a flow chart of an example method of generating a plurality of I/O requests based on a target address according to one or more embodiments of the present disclosure;

FIG. 5A shows a schematic diagram of example target data according to one or more embodiments of the present disclosure;

FIG. 5B shows a schematic diagram of an example first data segment, second data segment, and third data segment according to one or more embodiments of the present disclosure; and

FIG. 6 illustrates a block diagram of an example device that can be used to implement one or more embodiments of the present disclosure.

### DETAILED DESCRIPTION

Principles of the present disclosure will be described below with reference to several example embodiments shown in the accompanying drawings. Although preferred embodiments of the present disclosure are shown in the accompanying drawings, it should be understood that these embodiments are described merely to enable those skilled in the art to better understand and then implement the present disclosure, and do not to limit the scope of the present disclosure in any way.

The term “include” and variants thereof used herein indicate open-ended inclusion, that is, “including but not limited to.” Unless specifically stated, the term “or” means “and/or”. The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

The term “I/O” (Input/Output) used herein, that is, input/output, typically refers to the input and output of data between an internal memory and an external memory or other peripheral devices. An input/output device can send data (output) to a computer and receive data (input) from a computer. A memory is usually a block device. The block device is a device that can store information of blocks with fixed sizes, which supports reading and (optional) writing of data in fixed-size blocks, sectors, or clusters. Each block has its own physical address. Usually, the size of a block may be between 512 and 65536 bytes. All transmitted information will be in units of continuous blocks. Common block devices have hard drives, Blu-ray discs, and USB disks. Block devices are mainly involved herein, and corresponding I/O operations are reading or writing on the block devices.

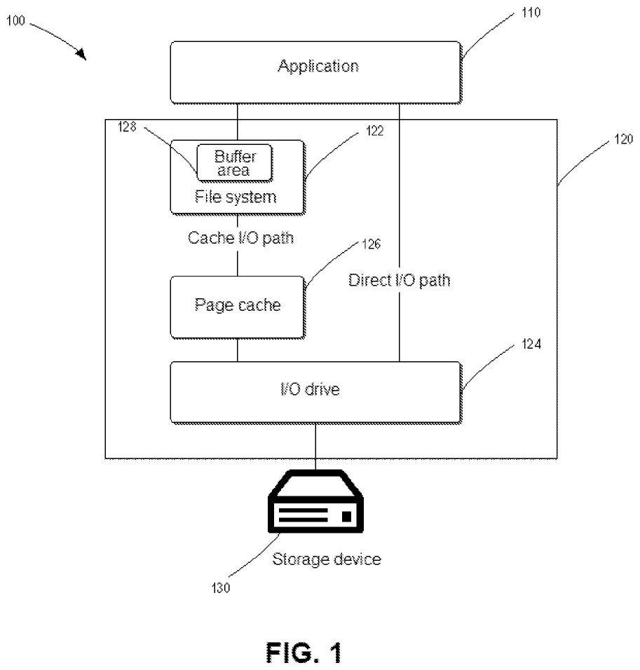

FIG. 1 shows a schematic block diagram of example storage system 100 that performs cache I/O operations and direct I/O operations. As shown in FIG. 1, conventionally, three parts are mainly involved when an I/O operation is executed, namely, an application which sends an I/O request, a storage management system that processes the I/O request, and a physical device that executes physical operations. The application is, for example, various processes called by a user. In the storage management system, multiple layers associated with an operating system are provided, and the multiple layers are associated in a particular manner to implement a variety of operational functions. The storage management system is sometimes also referred to as a kernel space. After the kernel space receives the I/O request, the I/O request is sequentially processed by the multiple layers associated with the I/O operation to drive the physical device to implement physical I/O operations. In kernel spaces of different systems, the configuration of the layers are different. The multiple layers described herein are merely illustrative, and the layer structure can be selected according to specific application scenarios.

I/O functions, file system 122 and I/O drive 124, for example, can be set in the kernel space. File system 122 can process the I/O request from the application, and then send the I/O request to a corresponding I/O request queue in I/O drive 124. In response to the corresponding I/O request, the I/O drive drives the physical device to perform I/O operations. There are two transmission paths between user 110 and storage device 130, which are a buffer I/O path and a direct I/O path, respectively.

Cache I/O operations performed on the cache I/O path are also referred to as standard I/O operations, and default I/O operations of a conventional file system are all cache I/O operations. In a cache I/O operation, for example, when a read operation is performed, if target data is in page cache 126 in storage management system 120, the data is read and returned to application 110 directly, and if the target data is not in page cache 126, the data is copied from storage device 130 to page cache 126. Then, the data is copied from page cache 126 to buffer address 128 assigned by application 110. It should be understood that the position of buffer address 128 shown in FIG. 1 is merely an example, which may be a storage space in a buffer area set at any position. Accordingly, when a write operation is performed, the data will be copied from buffer address 128 assigned by application 110 to page cache 126 first, and then is written into storage device 130. For example, in Linux, a delayed write mechanism is also set. When the data is written to page cache 126, it means that the write operation is completed, and storage management system 120 will periodically flush the data in page cache 126 to storage device 130. Relatively, direct I/O operations performed on the direct I/O path are more direct. When direct I/O operations are performed, data is directly transmitted between a buffer address assigned by the application and a disk. There is no page cache in the middle.

Conventionally, each I/O operation either uses a direct I/O operation or a cache I/O operation. As performance and capacity requirements continue to increase, file systems have become a performance bottleneck for specific applications. For example, in a virtualized device system, the performance of a memory is also limited by a file system and cannot meet the requirements of a new platform.

In addition, for example, when an NVMe solid state drive is used, a conventional NVMe solid state drive is often considered as a standard block device, which enhances performance by using a page cache. If the NVMe solid state drive is used directly in the virtualized system to replace existing devices and a file system in an existing system kernel is directly used, when I/O operations are performed on small pieces of data, it will result in large reduction of read and write efficiency.

For the above limitation, the present disclosure provides a hybrid I/O solution using buffer I/O operations and direct I/O operations to solve one or more of the above problems and other potential problems. In general, according to the embodiments described herein, a plurality of I/O sub-requests are generated based on I/O requests for target data, and a data segment targeted by one of the I/O sub-requests is made to meet the conditions for executing direct I/O operations, then the direct I/O operations are executed for this data segment to maximize the utilization of the direct I/O mode, thereby increasing the efficiency of the I/O operations.

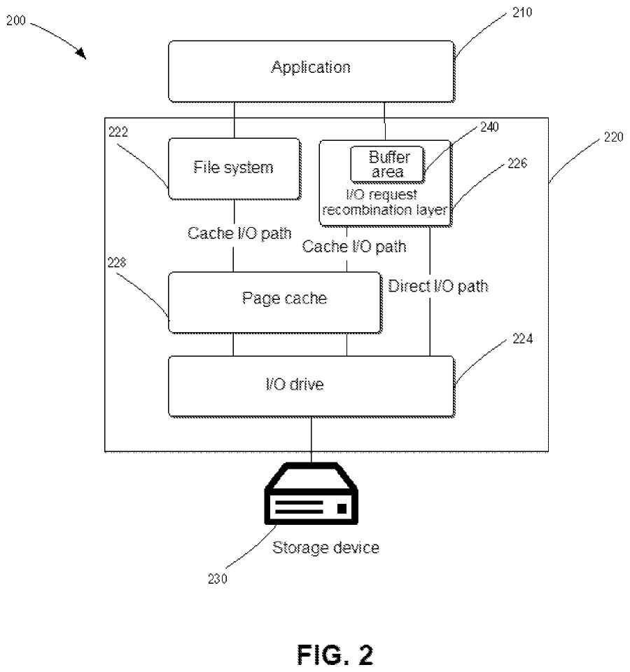

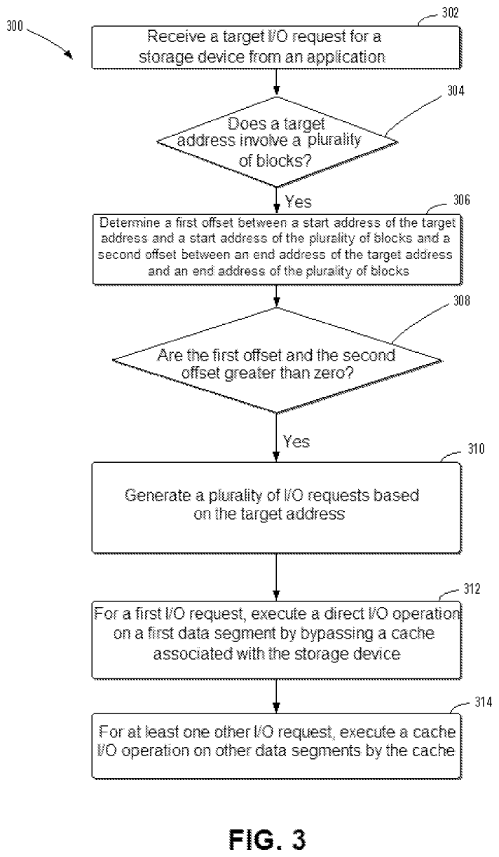

FIG. 2 shows a schematic block diagram of storage system 200 according to one or more embodiments of the present disclosure. As shown in FIG. 2, I/O request recombination layer 226 is also set in system kernel 220 in addition to file system 222 similar to the system shown in FIG. 1. Buffer address 240 that is assigned by application 210 to store data may exist in I/O request recombination layer 226. I/O request recombination layer 226 may receive an I/O request from application 210, and execute an example method (e.g., example method 300 shown in FIG. 3) according to embodiments of the present disclosure for recombination of the I/O request. I/O request recombination layer 226 provides a direct I/O path and a buffer I/O path. For example, when I/O request recombination layer 226 performs a read operation in response to a target I/O request from application 210, if target data is in page cache 228 in storage management system 220, the target data is read and directly returned to application 210, and if the target data is not in page cache 228, the data is copied from storage device 230 to page cache 228. Then, the data is copied from page cache 228 to buffer address 240 assigned by application 210. When the direct I/O operation is performed, the target data is directly transmitted between buffer address 240 and storage device 230.

It should be understood that the components and devices shown in FIG. 2 are merely illustrative. Storage management system 220 may include more, fewer, or different components. The functions described in different components can be implemented by a single component, or the functions described in a single component can be divided to be implemented by multiple components. Further, although only single application 210 and single storage device 230 are shown, there can be more applications and more storage devices in actual scenarios. The scope of the embodiments of the present disclosure is not limited in this respect.

FIG. 3 shows a flow chart of example method 300 for inputting and outputting data according to one or more embodiments of the present disclosure. Method 300 may be implemented, for example, at the storage management system 220 of FIG. 2.

At block 302, storage management system 220 receives a target I/O request for storage device 230 from application 210, and data in storage device 230 is organized into blocks having predetermined sizes. The target I/O request indicates a target address of target data stored in storage device 230. For example, I/O request recombination layer 226 in storage management system 220 may receive the target I/O request from application 210.

In one or more embodiments, the target I/O request may be a read request for reading the target data in the target address located in storage device 230, or may be a write request for writing the target data into the target address in storage device 230. In one or more embodiments, storage device 230 is a block device discussed above, and a block size may be, for example, 512 B and 1 KB.

At block 304, storage management system 220 (e.g., I/O request recombination layer 226) determines that the target address indicated by the received target I/O request involves one block or a plurality of blocks in storage device 230.

If it is determined that the target address only involves one block, storage management system 220 (e.g., I/O request recombination layer 226) may perform an I/O operation on the target data according to a conventional manner.

If it is determined that the target address involves a plurality of blocks, at block 306, storage management system 220 (e.g., I/O request recombination layer 226) determines a first offset between a start address of the target address and a start address of the plurality of blocks and a second offset between an end address of the target address and an end address of the plurality of blocks.

In one or more embodiments, the target I/O request may include an identifier of the block where the target address is located, thereby obtaining addresses of the plurality of blocks where the target address is located. It should be understood that the blocks discussed herein are logical blocks, which correspond to physical blocks in the storage device. In one or more embodiments, the I/O request may indicate an offset between the target address and the block address and a length of the target address, that is, a size of the target address. The start address and end address of the target address may be obtained depending on the offset and the length.

Depending on a size of target data of a specific request, the determined first offset and/or the second offset may be greater than zero or equal to zero. For example, the target data to be accessed may start with a non-starting position of the first block in the plurality of blocks, and/or may terminate at a non-ending position of the last block in the plurality of blocks. That is, the span of the target address of the target data may not be always aligned with the span of the plurality of blocks involved, so that the first offset and/or the second offset may be greater than zero.

At block 308, storage management system 220 (e.g., I/O request recombination layer 226) determines whether the first offset and the second offset are greater than zero.

If it is determined that the first offset or the second offset is greater than zero, at block 310, storage management system 220 (e.g., I/O request recombination layer 226) generates a plurality of I/O requests based on the target address, wherein the plurality of I/O requests include a first I/O request for a first data segment in the target data and at least one other I/O request for other data segments in the target data, a size of the first data segment is an integer multiple of a block size, and an offset between a start address of the first data segment and the start address of the plurality of blocks is also an integer multiple of the block size.

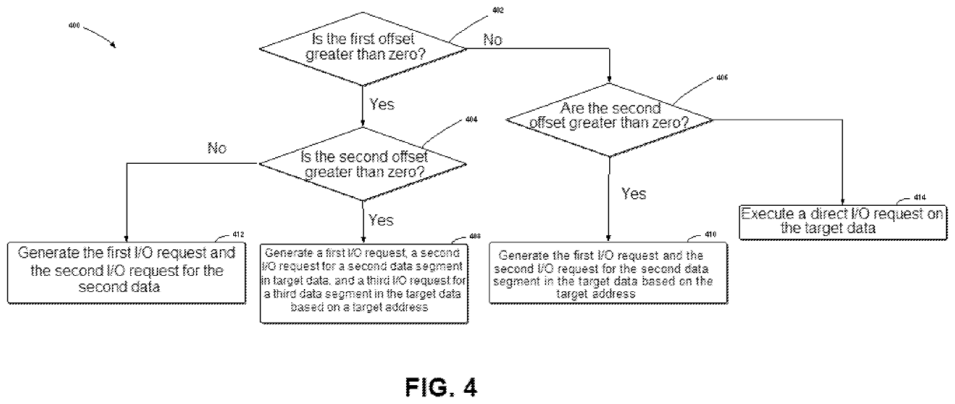

As described above, a variety of offset conditions may be determined based on possible values of the first offset and the second offset. The value of each of the first offset and the second offset may be greater than zero or equal to zero. The process of generating different I/O requests under different offset conditions will be described in detail in conjunction with the flow chart of FIG. 4.

FIG. 4 shows a flow chart of example method 400 of generating a plurality of I/O requests based on a target address according to one or more embodiments of the present disclosure. Method 400 may be executed, for example, by the I/O request recombination layer 226 in FIG. 2. Method 400 may be considered as an example implementation of the operations shown in block 308 and block 310.

At block 402, storage management system 220 (e.g., I/O request recombination layer 226) determines whether the first offset is greater than zero. If the first offset is greater than zero, the method proceeds to block 404, and if the first offset is equal to zero, the method proceeds to block 406.

At block 404, storage management system 220 (e.g., I/O request recombination layer 226) determines whether the second offset is greater than zero, the method proceeds to block 408 if the second offset is greater than zero, and the method proceeds to block 412 if the second offset is equal to zero.

At block 408, storage management system 220 (e.g., I/O request recombination layer 226) generates the first I/O request, a second I/O request for a second data segment in the target data, and a third I/O request for a third data segment in the target data based on the target address. A start address of the second data segment is the start address of the target address, an end address of the second data segment is adjacent to a start address of the first data segment, a start address of the third data segment is adjacent to an end address of the first data segment, and an end address of the third data segment is the end address of the target address.

At block 412, storage management system 220 (e.g., I/O request recombination layer 226) generates the first I/O request and the second I/O request for the second data segment in the target data based on the target address. The start address of the second data segment is the start address of the target address, and the end address of the second data segment is adjacent to the start address of the first data segment.

At block 406, storage management system 220 (e.g., I/O request recombination layer 226) determines whether the second offset is greater than zero, the method proceeds to block 410 if the second offset is greater than zero, and the method proceeds to block 414 if the second offset is equal to zero.

At block 410, storage management system 220 (e.g., I/O request recombination layer 226) generates the first I/O request and the second I/O request for the second data segment in the target data based on the target address. The start address of the second data segment is adjacent to the end address of the first data segment, and the end address of the second data segment is the end address of the target address.

At block 414, storage management system 220 (e.g., I/O request recombination layer 226) generates a direct I/O request for a target.

In one or more embodiments, in the case where start addresses have an offset, a third offset between the end address of the target data and the start address of the plurality of blocks may be determined. In response to that the third offset is greater than a size of a page in the cache, the offset between the start address of the first data segment and the start address of the plurality of blocks is set to be the size of the page. It should be understood that the size of the page is an integer multiple of the block size of the storage device. For example, in a case where the block size is 512 B, the size of the page may be 4 KB. Therefore, the size of the second data segment is made as close to the page size as possible, thereby increasing the speed of executing a cache I/O operation on the second data segment.

Similarly, in a case where end addresses have an offset, a fourth offset between the start address of the target data and the end address of the plurality of blocks may be determined. In response to that the fourth offset is greater than a size of a page in the cache, the offset between the end address of the first data segment and the end address of the plurality of blocks is set to be the size of the page.

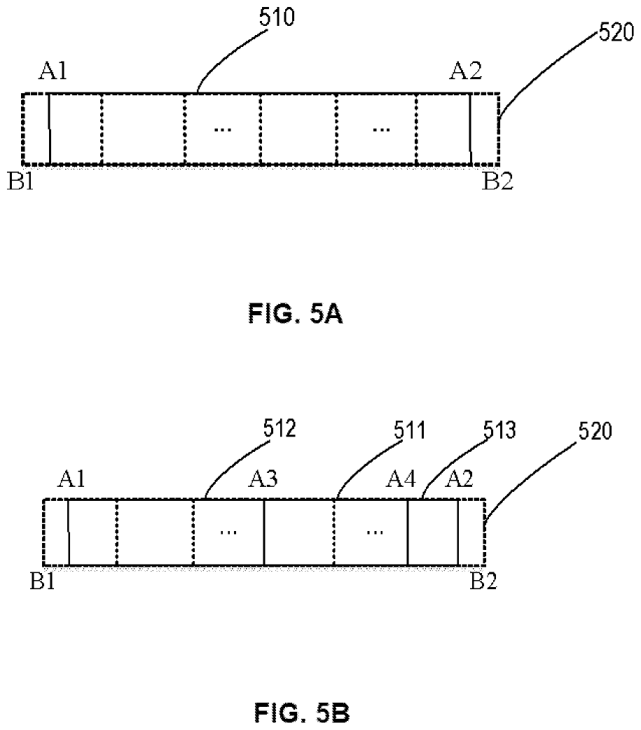

In this regard, FIGS. 5A and 5B respectively show schematic diagrams of example target data and an example first data segment, second data segment, and third data segment according to one or more embodiments of the present disclosure. FIGS. 5A and 5B particularly show the target data for the condition where the first offset and the second offset are both greater than zero, and an offset between the end address of the target data and the start address of the blocks is greater than the size of the page.

In the example shown in FIG. 5A, a plurality of blocks involved by target data 510 associated with a target I/O request are shown by dashed lines, and target data 510 is stored in the plurality of blocks. The location of target data 510 to be accessed is shown by solid lines. The start address of target data 510 is A1, and the end address is A2. The plurality of continuous blocks constitute block group 520, and block group 520 has start address B1 and end address B2. It can be seen that the offset between start address A1 of the target data and start address B1 of block group 520 is greater than zero, and the offset between end address A2 of the target data and end address B2 of block group 520 is also greater than zero. As described above, in response to this, a first I/O request, a second I/O request, and a third I/O request are generated based on the target I/O request, thereby obtaining first data segment 511, second data segment 512, and third data section 513.

First data segment 511, second data segment 512, and third data segment 513 are shown in FIG. 5B. Here, it is determined that the offset between end address A2 and start address B1 is greater than the size of the page in the cache. In response to this, address A3 whose offset from start address B1 is equal to the page size is determined as the start address of the first data segment 511, and address A4 whose offset from end address B2 is equal to the block size is determined as the end address of first data segment 511, thereby obtaining first data segment 511 with both the size and the offset from the start address being an integer multiple of the block size. Second data segment 512 is located in front of first data segment 511, and third data segment 513 is located behind first data segment 511.

Returning to FIG. 3, at block 312, for the first I/O request, storage management system 220 (e.g., I/O request recombination layer 226) executes a direct I/O operation on the first data segment by bypassing cache 228 associated with storage device 230.

In one or more embodiments, I/O request recombination layer 226 may send the first I/O request to an I/O request queue that utilizes direct I/O operations, and the first I/O request will wait to be executed in the queue.

In one or more embodiments, the first data segment targeted by the first I/O request further needs to meet other conditions before the first I/O request is sent to the I/O request queue. For example, I/O request recombination layer 226 may determine a buffer address of the first data segment in buffer area 240 associated with application 210, and determine a buffer offset between the buffer address and a start address of buffer area 240. If the buffer offset is greater than zero, I/O request recombination layer 226 may set a new buffer address in buffer area 240, so that an offset between the new buffer address and the start address of buffer area 240 is an integer multiple of the block size. Thus, when the direct I/O operation is executed on the first data segment, the first data segment may be copied to the new buffer address, and then copied from the new buffer address to a buffer address assigned by application 240.

At block 310, for the at least one other I/O request, storage management system 220 (e.g., I/O request recombination layer 226) executes a cache I/O operation on the other data segments by cache 228. The other data segments refer to the data segments different from the first data segment, and sizes or offsets from the start address of these data segments are not an integer multiple of the block size. For example, in the embodiment discussed above with reference to FIGS. 4 and 5A-5B, other data segments may include the second data segment and the third data segment.

In one or more embodiments, I/O request recombination layer 226 may send the at least one other I/O request to an I/O request queue that utilizes cache I/O operations, and these I/O requests wait to be executed in the queue.

In one or more embodiments, the at least one other I/O request may also indicate that: the cache I/O operation includes a cache flush. Therefore, the atomicity of a write operation in the cache I/O operation may be guaranteed.

By executing example method 300 shown in FIG. 3, a hybrid I/O operation on the target data is implemented, thereby improving the efficiency of overall I/O operations on the target data.

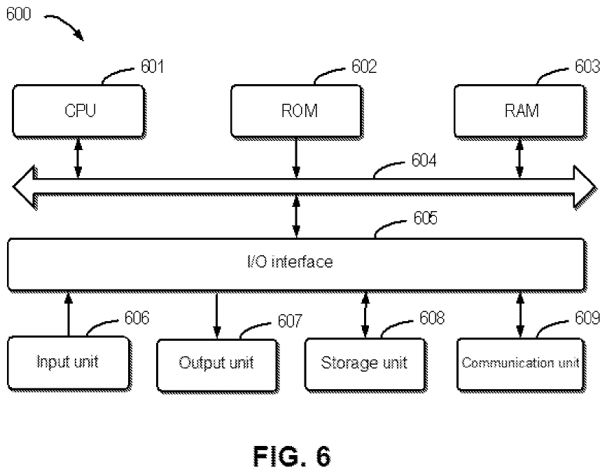

FIG. 6 illustrates a schematic block diagram of example device 600 that can be used to implement one or more embodiments of the present disclosure. As shown in FIG. 6, device 600 includes central processing unit (CPU) 601 that may perform various appropriate actions and processing according to computer program instructions stored in read-only memory (ROM) 602 or computer program instructions loaded from storage unit 608 to random access memory (RAM) 603. In RAM 603, various programs and data required for the operation of device 600 may also be stored. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices via a computer network, such as the Internet, and/or various telecommunication networks.

The various processes and processing described above, such as method 300 and/or method 400, may be performed by processing unit 601. In one or more embodiments, method 300 and/or method 400 may be implemented as a computer software program that is tangibly included in a machine-readable medium such as storage unit 608. In one or more embodiments, part or all of the computer program may be loaded and/or installed onto device 600 via ROM 602 and/or communication unit 609. When the computer program is loaded to RAM 603 and executed by CPU 601, one or more actions of method 300 and/or method 400 described above may be executed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read only memory (EPROM or flash memory), a static random access memory (SRAM), a portable compact disk read only memory (CD-ROM), a digital versatile disk (DVD), a memory stick, a floppy disk, a mechanical encoding device such as a punch card or a protruding structure within a groove having instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming language such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In one or more embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described here with reference to flow charts and/or block diagrams of the method, the apparatus (system), and the computer program product implemented according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. The computer-readable program instructions may also be stored in the computer-readable storage medium. The instructions enable a computer, a programmable data processing apparatus, and/or other devices to operate in a specific manner, so that the computer-readable medium storing the instructions includes an article of manufacture that includes instructions for implementing various aspects of functions/actions specified in one or more blocks in the flow charts and/or the block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flow charts as well as a combination of blocks in the block diagrams and/or flow charts may be implemented using a special hardware-based system that executes specified functions or actions, or implemented using a combination of special hardware and computer instructions.

The embodiments of the present disclosure have been described above. The above description is illustrative, rather than exhaustive, and is not limited to the disclosed various embodiments. Numerous modifications and alterations are apparent to those of ordinary skill in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed here.

1. A method for inputting and outputting data, comprising:
receiving a target I/O request for a storage device from an application, wherein data in the storage device is organized into blocks having predetermined sizes, and the target I/O request indicates a target address of target data;
in response to determining that the target address involves a plurality of blocks, determining a first offset between a start address of the target address and a start address of the plurality of blocks and a second offset between an end address of the target address and an end address of the plurality of blocks;
in response to determining that the first offset or the second offset is greater than zero, generating a plurality of I/O requests based on the target address, wherein the plurality of I/O requests include a first I/O request for a first data segment in the target data and at least one other I/O request for other data segments in the target data, a size of the first data segment is an integer multiple of a block size, and an offset between a start address of the first data segment and the start address of the plurality of blocks is also an integer multiple of the block size;
for the first I/O request, executing a direct I/O operation on the first data segment by bypassing a cache associated with the storage device; and
for the at least one other I/O request, executing a cache I/O operation on the other data segments by the cache.

2. The method according to claim 1, wherein generating the plurality of I/O requests based on the target address comprises:
in response to determining that the first offset is greater than zero and the second offset is zero, generating the first I/O request and a second I/O request for a second data segment in the target data based on the target address,
wherein a start address of the second data segment is the start address of the target address and an end address of the second data segment is adjacent to the start address of the first data segment.

3. The method according to claim 1, wherein generating the plurality of I/O requests based on the target address comprises:
in response to determining that the first offset is zero and the second offset is greater than zero, generating the first I/O request and a second I/O request for a second data segment in the target data based on the target address,
wherein a start address of the second data segment is adjacent to an end address of the first data segment, and an end address of the second data segment is the end address of the target address.

4. The method according to claim 1, wherein generating the plurality of I/O requests based on the target address comprises:
in response to determining that the first offset and the second offset are both greater than zero, generating the first I/O request, a second I/O request for a second data segment in the target data, and a third I/O request for a third data segment in the target data based on the target address,
wherein a start address of the second data segment is the start address of the target address, an end address of the second data segment is adjacent to the start address of the first data segment, a start address of the third data segment is adjacent to an end address of the first data segment, and an end address of the third data segment is the end address of the target address.

5. The method according to claim 1, further comprising:
before the first I/O request is sent to an I/O request queue, determining a buffer address of the first data segment in a buffer area;
determining a buffer offset between the buffer address and a start address of the buffer area; and
in response to determining that the buffer offset is greater than zero, setting a new buffer address for the first data segment, wherein an offset between the new buffer address and the start address of the buffer area is an integer multiple of the block size, and
copying the first data segment to the new buffer address prior to executing the direct I/O operation on the first data segment.

6. The method according to claim 1, further comprising:
determining a third offset between an end address of the target data and the start address of the plurality of blocks; and
in response to determining that the third offset is greater than a size of a page in the cache, setting the offset between the start address of the first data segment and the start address of the plurality of blocks to be the size of the page.

7. The method according to claim 1, further comprising:
determining a fourth offset between a start address of the target data and the end address of the plurality of blocks; and
in response to determining that the fourth offset is greater than a size of a page in the cache, setting an offset between an end address of the first data segment and the end address of the plurality of blocks to be the size of the page.

8. An electronic device, comprising:
a processor; and
a memory coupled to the processor, the memory having instructions stored therein that, when executed by the processor, cause the device to execute actions comprising:
receiving a target I/O request for a storage device from an application, wherein data in the storage device is organized into blocks having predetermined sizes, and the target I/O request indicates a target address of target data;
in response to determining that the target address involves a plurality of blocks, determining a first offset between a start address of the target address and a start address of the plurality of blocks and a second offset between an end address of the target address and an end address of the plurality of blocks;
in response to determining that the first offset or the second offset is greater than zero, generating a plurality of I/O requests based on the target address, wherein the plurality of I/O requests include a first I/O request for a first data segment in the target data and at least one other I/O request for other data segments in the target data, a size of the first data segment is an integer multiple of a block size, and an offset between a start address of the first data segment and the start address of the plurality of blocks is also an integer multiple of the block size;
for the first I/O request, executing a direct I/O operation on the first data segment by bypassing a cache associated with the storage device; and
for the at least one other I/O request, executing a cache I/O operation on the other data segments by the cache.

9. The electronic device according to claim 8, wherein generating the plurality of I/O requests based on the target address comprises:
in response to determining that the first offset is greater than zero and the second offset is zero, generating the first I/O request and a second I/O request for a second data segment in the target data based on the target address,
wherein a start address of the second data segment is the start address of the target address and an end address of the second data segment is adjacent to the start address of the first data segment.

10. The electronic device according to claim 8, wherein generating the plurality of I/O requests based on the target address comprises:
in response to determining that the first offset is zero and the second offset is greater than zero, generating the first I/O request and a second I/O request for a second data segment in the target data based on the target address,
wherein a start address of the second data segment is adjacent to an end address of the first data segment, and an end address of the second data segment is the end address of the target address.

11. The electronic device according to claim 8, wherein generating the plurality of I/O requests based on the target address comprises:
in response to determining that the first offset and the second offset are both greater than zero, generating the first I/O request, a second I/O request for a second data segment in the target data, and a third I/O request for a third data segment in the target data based on the target address,
wherein a start address of the second data segment is the start address of the target address, an end address of the second data segment is adjacent to the start address of the first data segment, a start address of the third data segment is adjacent to an end address of the first data segment, and an end address of the third data segment is the end address of the target address.

12. The electronic device according to claim 8, wherein the actions further comprise:
before the first I/O request is sent to an I/O request queue, determining a buffer address of the first data segment in a buffer area of a storage management system;
determining a buffer offset between the buffer address and a start address of the buffer area; and
in response to determining that the buffer offset is greater than zero, setting a new buffer address for the first data segment, wherein an offset between the new buffer address and the start address of the buffer area is an integer multiple of the block size, and
copying the first data segment to the new buffer address prior to executing the direct I/O operation on the first data segment.

13. The electronic device according to claim 8, wherein the actions further comprise:
determining a third offset between an end address of the target data and the start address of the plurality of blocks; and
in response to determining that the third offset is greater than a size of a page in the cache, setting the offset between the start address of the first data segment and the start address of the plurality of blocks to be the size of the page.

14. The electronic device according to claim 8, wherein the actions further comprise:
determining a fourth offset between a start address of the target data and the end address of the plurality of blocks; and
in response to determining that the fourth offset is greater than a size of a page in the cache, setting an offset between an end address of the first data segment and the end address of the plurality of blocks to be the size of the page.

15. A non-transitory computer-readable medium comprising computer readable program code, which when executed by a computer processor, enables the computer processor to:
receiving a target I/O request for a storage device from an application, wherein data in the storage device is organized into blocks having predetermined sizes, and the target I/O request indicates a target address of target data;
in response to determining that the target address involves a plurality of blocks, determining a first offset between a start address of the target address and a start address of the plurality of blocks and a second offset between an end address of the target address and an end address of the plurality of blocks;
in response to determining that the first offset or the second offset is greater than zero, generating a plurality of I/O requests based on the target address, wherein the plurality of I/O requests include a first I/O request for a first data segment in the target data and at least one other I/O request for other data segments in the target data, a size of the first data segment is an integer multiple of a block size, and an offset between a start address of the first data segment and the start address of the plurality of blocks is also an integer multiple of the block size;
for the first I/O request, executing a direct I/O operation on the first data segment by bypassing a cache associated with the storage device; and
for the at least one other I/O request, executing a cache I/O operation on the other data segments by the cache.

16. The non-transitory computer-readable medium according to claim 15, wherein generating the plurality of I/O requests based on the target address comprises:
in response to determining that the first offset is greater than zero and the second offset is zero, generating the first I/O request and a second I/O request for a second data segment in the target data based on the target address,
wherein a start address of the second data segment is the start address of the target address and an end address of the second data segment is adjacent to the start address of the first data segment.

17. The non-transitory computer-readable medium according to claim 15, wherein generating the plurality of I/O requests based on the target address comprises:
in response to determining that the first offset is zero and the second offset is greater than zero, generating the first I/O request and a second I/O request for a second data segment in the target data based on the target address,
wherein a start address of the second data segment is adjacent to an end address of the first data segment, and an end address of the second data segment is the end address of the target address.

18. The non-transitory computer-readable medium according to claim 15, wherein generating the plurality of I/O requests based on the target address comprises:
in response to determining that the first offset and the second offset are both greater than zero, generating the first I/O request, a second I/O request for a second data segment in the target data, and a third I/O request for a third data segment in the target data based on the target address,
wherein a start address of the second data segment is the start address of the target address, an end address of the second data segment is adjacent to the start address of the first data segment, a start address of the third data segment is adjacent to an end address of the first data segment, and an end address of the third data segment is the end address of the target address.

19. The non-transitory computer-readable medium according to claim 15, further comprising:
before the first I/O request is sent to an I/O request queue, determining a buffer address of the first data segment in a buffer area;
determining a buffer offset between the buffer address and a start address of the buffer area; and
in response to determining that the buffer offset is greater than zero, setting a new buffer address for the first data segment, wherein an offset between the new buffer address and the start address of the buffer area is an integer multiple of the block size, and
copying the first data segment to the new buffer address prior to executing the direct I/O operation on the first data segment.

20. The non-transitory computer-readable medium according to claim 15, further comprising:
determining a third offset between an end address of the target data and the start address of the plurality of blocks; and
in response to determining that the third offset is greater than a size of a page in the cache, setting the offset between the start address of the first data segment and the start address of the plurality of blocks to be the size of the page.
